(19) United States
(12) Patent Application Publication
(10) Pub. No.: US 2005/0146501 A1
(43) Pub. Date: Jul. 7, 2005

(54) Wireless mouse with a PC camera

(76) Inventor: Cliff Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/747,281

(22) Filed: Dec. 30, 2003

(51) Int. Cl. G09G 5/08

(52) U.S. Cl. 345/163

(57) ABSTRACT

A wireless mouse with a camera lens is described. The mouse has a housing with an upper cover and a lower cover, a wireless mouse circuit and a camera circuit. The wireless mouse circuit and the camera circuit are separately installed on one side of the lower cover of the wireless mouse and on one side of the upper cover of the wireless mouse. A button is further installed on one side of the wireless mouse housing. The wireless mouse circuit and the camera circuit operate respectively. Therefore, the user can individually employ the function of the wireless mouse or the function of the camera.

### BACKGROUND OF THE INVENTION

1. Field of the Invention

The present invention relates to a wireless mouse with a PC camera, and more particularly, to a device having functions of camera and wireless mouse.

2. Description of the Prior Art

Nowadays, a mouse is a required peripheral device of the computer. The mouse has developed from a RS-232 mouse to a PS/2 mouse, and, most recently, to an optical wireless mouse. However, although the mouse is critical, a mouse that only functions as a mouse is dull. Some manufacturers are conscious of this and devote much time and energy to promoting additional roles for the mouse.

Reference is made to FIG. 1. FIG. 1 is a perspective diagram of a prior art mouse system with a digital camera function. The mouse system comprises a mouse key and mouse rolling wheel 11, a universal serial bus interface 12, a flash memory 13, an image processor 14, a shutter engine 15, a dynamic random access memory 16, a movement processor 17, a detector 18, an analog/digital converter 19, a sensitization-coupling device 20, a lens 21, a selected object 22, and a second lens 24.

In the U.S. Pat. No. 6,525,306, a computer mouse integrated with a digital camera and its method is provided, and integration of a digital camera with a computer mouse is disclosed. However, it has the drawbacks of having a more complicated structure and a higher production cost. Undoubtedly, the complicated structure increases the production cost so as to make the price of this mouse much higher. This mouse will thus be unpopular and less competitive in the consumer product market while the prices of the other computer mice are continuously reducing.

### SUMMARY OF THE INVENTION

In order to resolve the above-mentioned problem, the present invention provides a wireless mouse with a PC camera. In the present invention, a wireless mouse circuit and a camera circuit are separately installed on one side of the lower cover of the wireless mouse and one side of the upper cover of the wireless mouse. Furthermore, a button is installed on one side of the wireless mouse housing. The wireless mouse circuit and the camera circuit operate respectively. Therefore, the user can individually employ the function of the wireless mouse or the function of the camera.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a prior art mouse system with digital camera function;

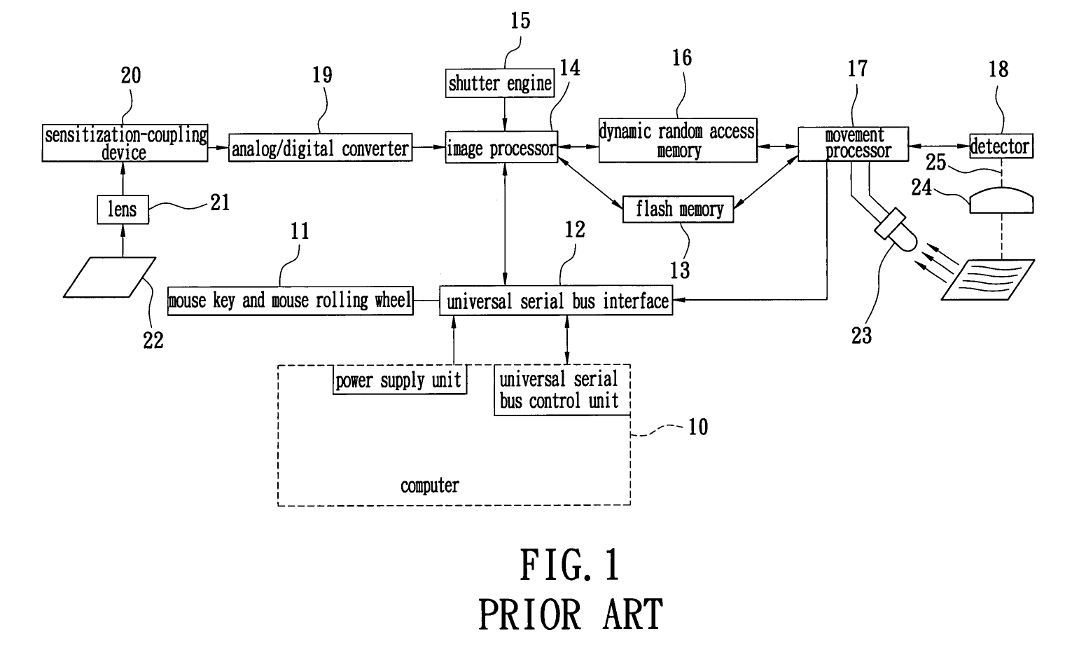

FIG. 2 shows the inner structure of the present invention;

FIG. 3 shows the outer appearance of the present invention; and

FIG. 4 is a block diagram of a circuit according to the present invention.

### DETAILED DESCRIPTION OF THE PREFERRED EMBODIMENT

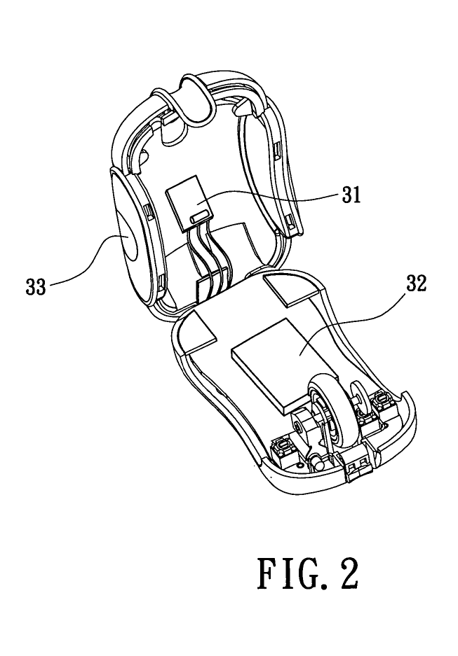

Please refer FIG. 2. FIG. 2 shows the inner structure of the present invention. The structure comprises a camera 31, a wireless mouse 32 and a button 33.

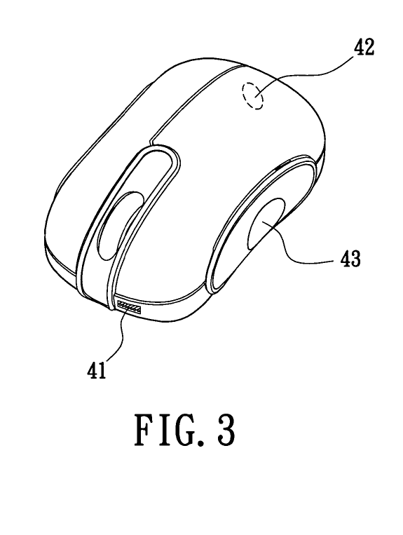

Reference is made to FIG. 3. FIG. 3 shows the outer appearance of the present invention. It comprises a universal serial bus interface 41, a CCD camera lens 42 and a button 43.

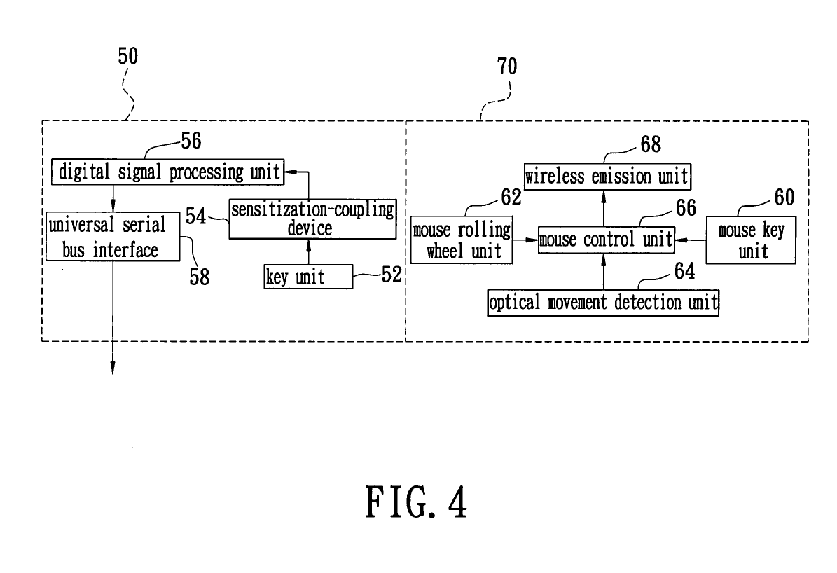

Reference is made to FIG. 4. FIG. 4 is the functional block diagram of the present invention. It comprises two big blocks of the PC camera 50, and the wireless mouse 70. The PC camera consists of a key unit 52, a CCD image capture unit 54, a digital signal processing unit 56, and a universal serial bus interface 58. The wireless mouse consists of a mouse key unit 60, a mouse rolling wheel unit 62, an optical movement detection unit 64, a mouse control unit 66, and a wireless transmission unit 68.

The user can apply the present invention as a general pointing device to a computer system, and the present invention is a wireless mouse. When the user is outdoors and wishes to take a photograph but has no camera in hand, the present invention is then an ideal substitute. The user can connect the present invention to a computer system with a USB cable, and the present invention then becomes a digital camera. When the user presses down the side button on the present invention, the camera circuit inside the present invention starts to operate. The CCD image capture unit of the camera circuit sends the image signals to the digital signal processing unit for digital conversion and image processing. Then, the digitized image signals are transferred to the main system via the USB interface circuit and the USB cable. On the system, the image can be displayed, recorded, forwarded to other people through the Internet.

The wireless mouse circuit and the camera circuit of the present invention operate individually, and are separately installed on the lower cover and the upper cover of the wireless mouse. Compared with the prior art, the present invention does not have the dynamic random access memory, the flash memory and the image processor, and therefore, has a lower production cost. In addition, the inner circuits operate individually and the functions can be separately employed.

As the present invention has the above-mentioned advantages, the mouse according to the present invention will be popular and competitive in the consumer product market and will be applied broadly in the daily life.

Those skilled in the art will readily observe that numerous modifications and alterations of the device may be made while retaining the teachings of the invention. Accordingly, the above disclosure should be construed as limited only by the metes and bounds of the appended claims.

1. A wireless mouse with a PC camera, comprising:
a housing, comprising an upper cover and a lower cover;
a wireless mouse circuit installed in the housing, comprising:
an optical movement detection unit;
a key unit;
a rolling wheel unit;
a mouse control unit for receiving the signals of the optical movement detection unit, the key unit, and the rolling wheel unit, and transforming these signals into data packets according to a specific wireless protocol; and
a wireless transmission unit for transmitting the said data packets to a computer over the air and through a wireless receiver; and
a PC camera module installed in the housing, comprising:
a key unit;
a CCD image capture unit for taking analog image;
a digital signal processing unit for digitally converting, processing, and compressing the signal of the analog image; and
a universal serial bus interface unit for transferring the image processed by the digital signal processing unit to a computer;
wherein operation of the camera circuit is independent of that of the inner wireless mouse circuit.

2. The wireless mouse with a PC camera of claim 1, wherein the wireless mouse circuit is further installed on one side of a lower cover of the wireless mouse.

3. The wireless mouse with a PC camera of claim 1, wherein the camera circuit is further installed on one side of an upper cover of the housing of the wireless mouse.

4. The wireless mouse with a PC camera of claim 1, wherein the key unit of the camera circuit is a button.

5. The wireless mouse with a PC camera of claim 4, wherein the button is installed on one side of the housing of the wireless mouse.
